(19) United States
(12) Patent Application Publication
(10) Pub. No.: US 2024/0249854 A1
(43) Pub. Date: Jul. 25, 2024

(54) IMPROVED ASSEMBLY COMPRISING A PACKAGING FOR TRANSPORTING AND/OR STORING RADIOACTIVE MATERIALS, AND A REMOVABLE HANDLING STRUCTURE

(71) Applicant: ORANO NUCLEAR PACKAGES AND SERVICES, Montigny-Le-Bretonneux (FR)

(72) Inventors: Christophe ROGER, NOISY-LE-GRAND (FR); Remi DAVID, VERSAILLES (FR); Franck GAZZINO, DONZERE (FR); Fabien COLLIN, ELANCOURT (FR); Yannick BRESSON; Romain DAVRON; Hérve RIPERT, PARIS (FR); Vincent RENARD, LE BOULLAY-THIERRY (FR)

(21) Appl. No.: 18/557,817

(22) PCT Filed: Apr. 28, 2022
(86) PCT No.: PCT/FR2022/050815

§ 371 Date: Oct. 27, 2023

(30) Foreign Application Priority Data
Apr. 30, 2021 (FR) 2104543

(51) Int. Cl. G21F 5/14; G21F 5/12

(52) U.S. Cl. CPC G21F 5/14; G21F 5/12

(57) ABSTRACT

An assembly includes a package for transporting and/or storing radioactive materials as well as a removable handling structure designed to be removably coupled on the first axial end of a lateral package body, the handling structure comprising a support device, as well as at least two separate package handling members. The first end includes one or more axial holding elements of the handling structure, whereas the handling structure includes at least one gripping device comprising an axial coupling member to the first axial end. Furthermore, in the coupled configuration of the handling structure, each axial coupling member is in contact or axially facing an axial stop surface of the axial holding element.

### TECHNICAL FIELD

The present invention relates to the field of packages for transporting and/or storing radioactive materials, for example radioactive waste placed in drums, or nuclear fuel assemblies.

The invention relates more specifically to the handling of these packages, and to the means for carrying out conventional handling operations, such as tilting the package from a horizontal position to a vertical position, and vice versa.

### PRIOR ART

Generally, packages have a body defining a cavity wherein the radioactive materials are housed. During transport, shock absorber caps are generally installed at the axial ends of this package body, in order to protect the structure of the latter in the event of a fall. The shock absorber caps can be removed during the storage of the radioactive materials, to save space on the storage site.

Moreover, according to the designs thereof, the package bodies can optionally be equipped with handling members, such as trunnions. In the case where such members are provided permanently on the package body, handling operations are carried out using these members, for example to tilt the package from a horizontal position to a vertical position, and vice versa.

However, the presence of the handling members on the package body, during the transport thereof, can lead to mechanical adjustment problems in the event of a fall. Indeed, these handling members represent weak points which require mechanical reinforcement to meet safety requirements. This reinforcement results in additional costs in terms of price and mass.

To address this problem, removable handling structures have been proposed, intended to be mounted on package bodies only for handling operations, and not during transport. For example, a removable ring solution bearing handling trunnions is known, and provided to be fastened on an axial end of the package body using a large number of screws. Another solution consists of providing discrete elements each equipped with a single handling trunnion, also assembled with screws onto the package body.

Nevertheless, these structures still could be improved, both in respect of the robustness thereof, and in terms of their ease of assembly/disassembly on the package body.

### DESCRIPTION OF THE INVENTION

In order to address the problem mentioned above, the invention relates to a package for transporting and/or storing radioactive materials, the package including a lateral package body, a bottom and a removable cover, the lateral package body extending about a central longitudinal axis of the package passing through the bottom and the cover, the lateral package body comprising a first axial end on the cover side, as well as a second axial end opposite the first, on the package bottom side,
the assembly also comprising a removable handling structure designed to be removably coupled on the first axial end of the lateral package body, the handling structure comprising a support device, as well as at least two separate package handling members rigidly connected to the support device, the latter extending about the first axial end of the lateral package body, in a coupled configuration of the handling structure with the package.

According to the invention, the first axial end of the lateral package body includes one or more axial holding elements of the handling structure, extending radially outwards relative to the central longitudinal axis, each axial holding element including an axial stop surface oriented towards the second axial end of the lateral package body.

Furthermore, the removable handling structure includes at least one gripping device borne by the support device, each gripping device comprising an axial coupling member to the first axial end of the lateral package body.

Finally, in the coupled configuration of the handling structure, each axial coupling member is in contact or axially facing the axial stop surface of one of said one or more axial holding elements provided on the first axial end of the lateral package body.

The invention proves to be particularly advantageous in that it makes it possible to provide a high degree of robustness in the mechanical coupling between the removable handling structure and the first axial end of the lateral package body, while offering very easy and quick assembly/disassembly.

The invention can provide the implementation of one of the following optional features, considered separately or in combination.

Preferably, the assembly is designed such that the switch from a non-coupled configuration of the handling structure, to the coupled configuration of this handling structure to the package, is performed by moving the support device of the handling structure, relative to the first axial end of the lateral package body. This makes it possible to make the assembly/disassembly of the removable handling structure on the package even quicker and easier. More preferably, the assembly is designed such that the relative movement is performed with the support device and the first axial end of the lateral package body remaining both inscribed in the same virtual relative movement plane, arranged orthogonally to the central longitudinal axis of the package. Further types of relative movement can nonetheless be envisaged between the removable handling structure and the lateral package body, without leaving the scope of the invention. According to a first preferred embodiment of the invention, the assembly is designed such that the relative movement is performed by rotating the support device relative to the first axial end of the lateral package body, along an axis of relative rotation corresponding to the central longitudinal axis of the package. In this first embodiment, each of the axial coupling members preferably forms, with the associated axial holding element thereof provided on the first axial end of the lateral package body, a bayonet or claw coupling mechanism. Assembly is found to be particularly quick and easy to implement.

Preferably, the support device includes a ring along which the gripping devices are spaced apart. In this first solution, the ring could nevertheless be only partial and not extend over 360°, without leaving the scope of the invention.

Preferably, the gripping devices also each include a radial stop member cooperating with the first axial end of the lateral package body. The cooperation obtained between these elements enables a radial coupling between the lateral package body, and the removable handling structure.

According to a second preferred embodiment of the invention, the removable handling structure is made from several angular structure sectors, each of the sectors comprising:
a part of the support device;
at least one of the handling members;
at least one gripping device.

Preferably, said part of the support device takes the form of an angular ring sector, and said at least one gripping device takes the form of a tab extending radially inwards from the angular ring sector, to form the axial coupling member, each tab extending preferably all along the associated angular ring sector thereof, so as to form a single axial coupling member inside each angular structure sector.

Preferably, in the coupled configuration, the angular structure sectors are mounted end-to-end to form an annular structure together, or the angular structure sectors are spaced apart so as to only form a part of an annular structure.

Preferably, said one of more axial holding elements, provided on the first axial end of the lateral package body, is formed by an annular collar extending radially outwards relative to the central longitudinal axis. Other solutions are nonetheless possible, such as angular collar sectors spaced apart along the circumferential direction, without leaving the scope of the invention.

Preferably, the parts of the support device each form a radial stop member cooperating with the first axial end of the lateral package body. Here also, the cooperation obtained between these elements enables a radial coupling between the lateral package body, and the removable handling structure.

In this second preferred embodiment of the invention, the assembly can be designed such that the movement of each angular structure sector, relative to the first axial end of the lateral package body, is performed by translation of the angular structure sector relative to the first axial end, in said virtual relative movement plane arranged orthogonally to the central longitudinal axis of the package.

According to an alternative, the assembly can be designed such that during the movement of the angular structure sectors, relative to the first axial end of the lateral package body to arrive at the coupled configuration, said angular structure sectors are connected to each other, preferably:
either end-to-end at only some of the ends thereof;
or via a structure for actuating the movement of the angular structure sectors.

According to a third preferred embodiment of the invention, the assembly is designed such that the switch from a non-coupled configuration of the handling structure, to the coupled configuration of this handling structure to the package, is performed by moving each gripping device of the handling structure, relative to the support device of said structure. These movements can be for example rotations or translations.

Regardless of the embodiment envisaged, the handling members are preferably provided in a number of two to four, and they preferably each take the form of a trunnion, a fork, or a lug, or any other handling member known to a person skilled in the art.

Preferably, to secure the coupling, the assembly comprises a device for locking the removable handling structure, in the coupled configuration with the first axial end of the lateral package body.

Other advantages and features of the invention will appear in the non-limiting detailed description hereinbelow.

### BRIEF DESCRIPTION OF THE DRAWINGS

This description will be given with reference to the appended drawings, wherein;

FIG. 1 represents, schematically, an axial longitudinal sectional view of a package for transporting and/or storing radioactive materials;

FIG. 2 represents an exploded perspective view of a part of an assembly according to a first preferred embodiment of the invention, this assembly comprising the package shown in the preceding figure, with its shock absorber caps removed, as well as a removable handling structure;

FIG. 3 represents a partial longitudinal sectional view of the assembly shown in the preceding figure, with the handling structure coupled with the package;

FIG. 4 is a perspective view showing the assembly during the coupling of the removable handling structure with the package;

FIG. 5 is a perspective view showing the assembly in the preceding figure, at a later stage during the coupling of the removable handling structure;

FIG. 6 is a perspective view showing the assembly in the preceding figure, at a later stage during the coupling of the removable handling structure;

FIG. 7 is a perspective view showing an assembly tilting operation, from a horizontal position to a vertical position;

FIG. 8 represents an exploded perspective view of a part of an assembly according to a second preferred embodiment of the invention, this assembly comprising the package shown in FIG. 1, with its shock absorber caps removed, as well as a removable handling structure;

FIG. 9 represents a perspective view similar to the preceding one, with the handling structure coupled with the package;

FIG. 10 represents a partial longitudinal sectional view of the assembly shown in the preceding figure, again with the handling structure coupled with the package;

FIG. 11 represents an exploded perspective view similar to that of FIG. 8, with the assembly presented according to an alternative embodiment;

FIG. 12 represents a perspective view similar to the preceding one, with the handling structure coupled with the package;

FIG. 13 represents an exploded perspective view similar to that of FIG. 12, with the assembly arranged in the horizontal position and presented according to a further alternative embodiment;

FIG. 14 represents the assembly shown in the preceding figure, while tilting this assembly from the horizontal position thereof to a vertical position;

FIG. 15 represents an exploded partial perspective view of an assembly, according to a third preferred embodiment of the invention.

### DETAILED DESCRIPTION OF PREFERRED EMBODIMENTS

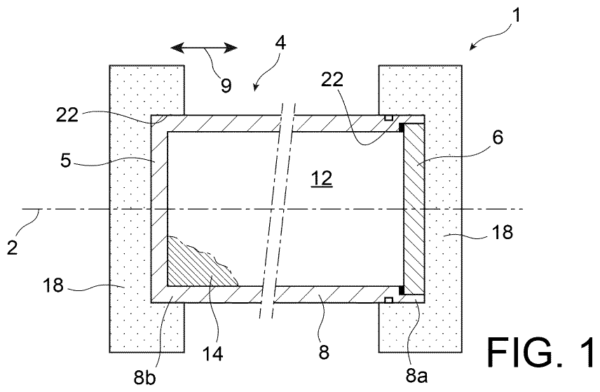

With reference firstly to FIG. 1, a package 1 for transporting and/or storing radioactive materials is represented schematically. The package 1 is represented in the horizontal transport position, i.e. with the central longitudinal axis 2 thereof oriented horizontally, namely parallel with the ground. This transport position contrasts with the vertical storage and/or operating position, wherein the central longitudinal axis 2 thereof is oriented vertically, namely orthogonally to the ground.

Conventionally, the package includes a package body 4 formed by a package bottom 5, a removable cover 6 opposite the bottom 5 along the direction of the axis 2, as well as a lateral package body 8. It is noted that the lateral body 8 extends about the axis 2, parallel with the direction 9 corresponding to the direction of the height of the package when the latter adopts the storage position thereof.

The bottom 5 and the cover 6 axially delimit a housing cavity 12 wherein the radioactive materials 14 are received. This cavity 12 is also delimited radially by the lateral body 8. The package body 4 is protected by one or two shock absorber caps 18. These caps 18 are designed to be able to be assembled and removed easily, as the presence thereof is not always essential. Generally, the caps 18 are removed during storage and/or during the operating operations, such as loading/unloading the radioactive materials of the package, and assembled at the opposite longitudinal ends of the package body 4 to equip this package during transport. Thus, as shown in FIG. 1, a shock absorber cap 18 equips a first axial end 8a of the lateral body 8 located at the cover 6, axially and laterally covering this cover as well as this first end 8a. Similarly, a further shock absorber cap 18 equips a second axial end 8b located at the bottom 5, axially and laterally covering this bottom 5, as well as this second end 8b. To do this, each shock absorber cap 18 preferably has a recess 22 to receive at least a part of the axial end 8a, 8b which is associated therewith. In other words, each axial end 8a, 8b of the lateral package body 8 nests in the recess 22 of the corresponding shock absorber cap 18.

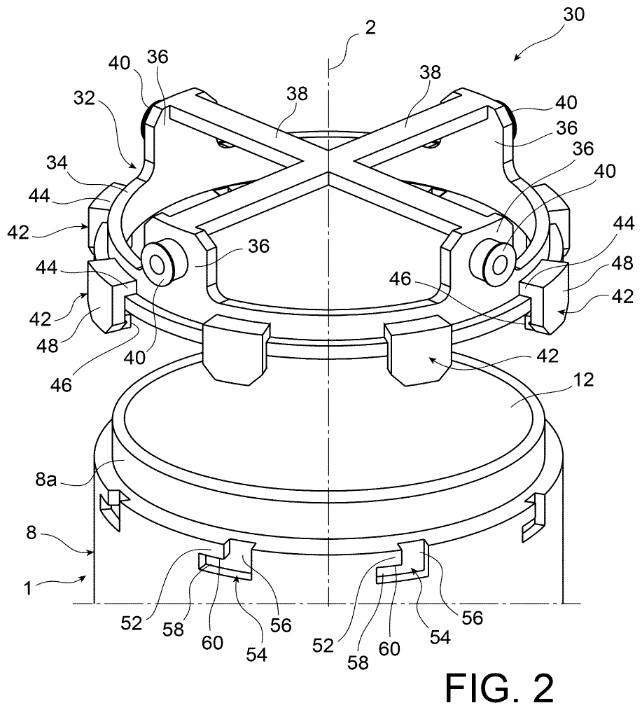

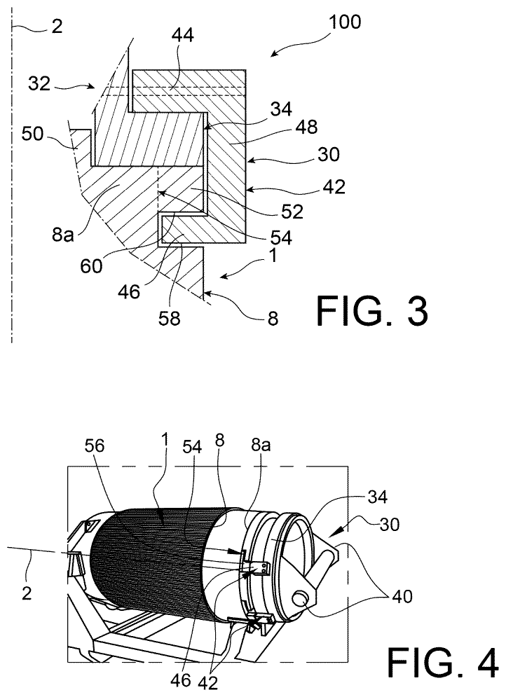

FIGS. 2 and 3 represent an assembly 100 according to a first preferred embodiment of the invention. The assembly 100 includes the package 1 free from the shock absorber caps thereof which have been removed, as well as a removable handling structure 30 specific to the present invention. The handling structure 30 is designed to be removably coupled onto the first axial end 8a, in order to allow the conventional handling operations of the package, such as the tilting thereof from the horizontal position to the vertical position, and vice versa. Obviously, this handling structure 30 is very preferably implemented when the package 1 is devoid of permanent handling members on the lateral body 8 thereof.

The removable handling structure 30 firstly includes a support device 32, comprising a ring 34 extending over 360° while being centred on the axis 2. The support device 32 can also comprise lugs 36 extending axially from the ring 34, as well as reinforcement beams 38 interconnecting the lugs 36.

The handling structure 30 also includes a plurality of separate handling members, here trunnions 40 rigidly connected to the lugs 36 of the support device 32. Each trunnion 40 is conventionally arranged with the central longitudinal axis thereof oriented radially. These trunnions 40 are here represented in a number of four, regularly distributed along the circumferential direction, but the number thereof could be different, for example two, diametrically opposite.

In the coupled configuration as shown in FIG. 3, the support device 32, and more specifically the ring 34 thereof, extends about the first axial end 8a.

The removable handling structure 30 also includes several gripping devices 42, borne by the support device 32. More preferably, the gripping devices 42 are distributed and spaced circumferentially apart along the ring 34 whereon they are fastened, for example using screws/bolts, while being mounted on the outer periphery of this ring 34. These gripping devices 42 can be provided in a number of eight, as in FIG. 2. Nevertheless, this number can be different, for example four.

Each gripping device 42 adopts a general recumbent U shape when the axis 2, whereon the handling structure 30 is centred, is arranged vertically. One of the arms 44 of the U serves as axial support for the gripping device 42 on the ring 34. The other arm 46 of the U forms an axial coupling member with the first end 8a of the lateral package body 8, as detailed hereinafter. Finally, the base 48 of the U, oriented vertically in FIG. 2, forms a radial stop member which, in the coupled configuration shown in FIG. 3, finds itself in contact or radially facing a periphery of the first axial end 8a. The cooperation obtained between these elements 8a, 48 enables a radial coupling between the lateral package body 8, and the removable handling structure 30, particularly useful during a tilting operation of the package 1. Simultaneously or alternatively, this radial coupling can be obtained between an end annular portion 50 of the axis end 8a, and the inner periphery of the ring 34, as seen in FIG. 3.

The first axial end 8a of the lateral package body 8 includes for its part a plurality of axial holding elements 52 of the handling structure 30. The number thereof corresponds to that of the gripping devices, as they are intended to cooperate pairwise. Each axial holding element 52 takes the form of a material block extending radially outwards to the periphery of the first axial end 8a, i.e. projecting outwards along the radial direction of the assembly 100, relative to the axis 2.

Each axial holding element 52 is defined by an adjacent recess 54, in a recumbent L shape when the assembly 100 is oriented vertically. More specifically, each recess 54 includes a radial opening 56, open radially outwards, which continues with a circumferential opening 58 also open radially outwards. It is the association of these two openings 56, 58 which forms the L-shaped recess, adapted to create a bayonet/claw coupling with the axial coupling member 46 of the associated gripping device 42.

In the coupled configuration, the axial coupling member 46 finds itself axially facing or in contact with an axial stop surface 60 defined by the axial holding element 52, this surface 60, preferably orthogonal to the axis 2, being oriented towards the second axial end 8b of the lateral package body. It is the cooperation between these two elements 52, 60 which provides the axial mechanical coupling between the handling structure 30 and the package 1, at the first axial end 8a thereof on the cover side.

For the mechanical coupling, reference is now made to FIGS. 4 to 6 showing different successive steps performed to mount the removable handling structure 30 on the first axial end 8a of the package, arranged in the horizonal position. In these figures, the number of handling trunnions 40 is reduced to two, whereas the number of gripping devices 42 is reduced to four, like the number of recesses 54 as well as the number of axial holding elements 52 defined by these recesses.

In FIG. 4, the handling structure 30 is firstly conveyed in proximity and coaxially to the first axis end 8a, with each axial coupling member 46 located axially facing and at a distance from the radial opening 56 of the associated recess 54 thereof.

For the positioning of the handling structure 30 on the axial end 8a, this structure 30 is moved axially until each axial coupling member 46 finds itself in the bottom of the radial opening 56 of the associated recess 54 thereof. The handling structure 30 then finds itself in a positioning configuration on the package, but non-coupled.

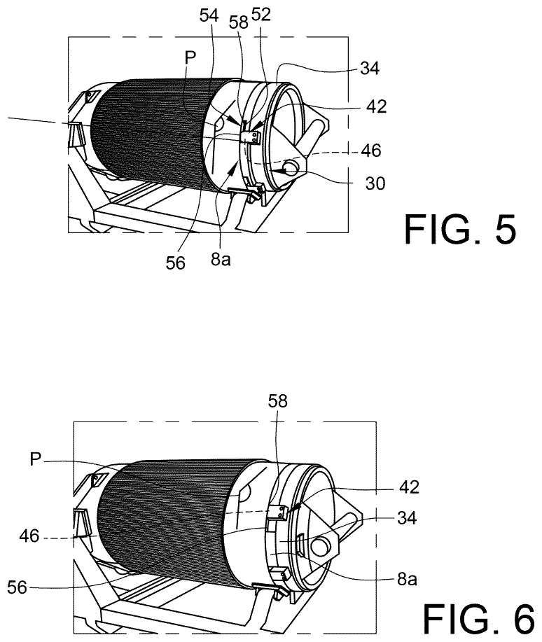

To switch from the non-coupled configuration of FIG. 5, to the coupled configuration of FIG. 6, the entire handling structure 30 is rotated relative to the package along the axis 2, according to a limited amplitude as usually encountered on bayonet mechanisms. This relative movement is performed with the ring 34 and the first axial end 8a both remaining inscribed in the same virtual relative movement plane P arranged orthogonally to the axis 2, this plane P therefore passing through the ring 34 and the end 8a throughout the movement of the handling structure 30 resulting in the coupled configuration. During this movement, each axial coupling member 46 is gradually inserted into the circumferential opening 58 of the associated recess 54 thereof, until it finds itself in the bottom of this opening 58, axially facing or in contact with the axial holding element 52, as seen in FIG. 3. The radial opening 56 thus finds itself released by the gripping device 42, but one or more of them can be equipped with a locking device (not shown) of the handling structure 30 in the coupled configuration. It can for example consist of a device mounted in this radial opening 56, and forming a circumferential stop for the axial coupling member 46.

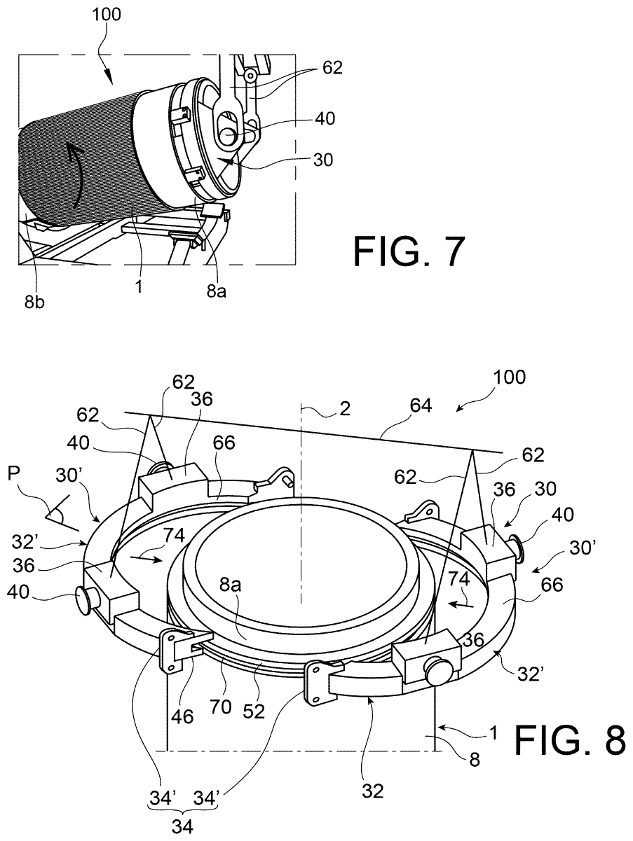

When the axial mechanical coupling has been carried out, push rods 62 can be connected to the trunnions 40, with these push rods 62 in turn connected to a lifting beam suspended from a gantry crane, so as to lift the structure 30 and trigger the tilting of the package 1 to the vertical position, as illustrated in FIG. 7. This tilting is then performed in a known manner, by pivoting the assembly 100 along a horizontal axis of rotation, close to or through the second axial end 8b of the lateral package body.

With reference to FIGS. 8 and 10, the assembly 100 according to a second preferred embodiment of the invention is represented. The assembly 100 includes the package 1 free from the shock absorber caps thereof which have been removed, as well as a removable handling structure 30 which is here segmented into several angular structure sectors 30′. More specifically, these are two sectors 30′ of approximately 180° each, intended to be mounted end-to-end in the coupled configuration, so as to form a complete annular structure together. The number of sectors 30′ could nonetheless be greater, without leaving the scope of the invention.

Each angular structure sector 30′ firstly includes a part 32′ of the support device 32, in particular comprising an angular ring sector 34′. End-to-end, the two angular ring sectors 34′ form the ring 34 extending over 360°, and centred on the axis 2. This feature is preferably retained in all the embodiments incorporating angular ring sectors, regardless of the number of sectors.

The part 32′ of the support device 32 also comprises one or more lugs 36, each extending axially from the ring sector 34′. Each angular structure sector 30′ also includes one or more separate handling members, here trunnions 40 rigidly connected to the lugs 36, and provided in a number of two per sector. Each trunnion 40 is here also conventionally oriented with the central longitudinal axis thereof oriented radially. The number of trunnions 40 could be different, for example two in total, diametrically opposite. As in the first embodiment, for the handling operations and in particular for the tilting of the package 1, the trunnions 40 are intended to cooperate with push rods 62, in turn connected to a lifting beam 64 suspended from a gantry crane.

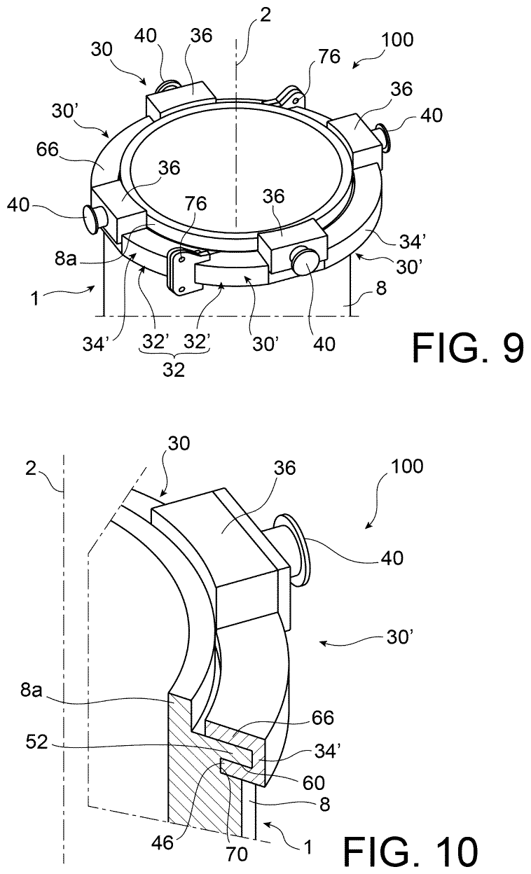

In the coupled configuration as shown in FIGS. 9 and 10, each part 32′ of the support device 32, and more specifically, each angular ring sector 34′, extends about the first axial end 8a.

Each angular structure sector 30′ also includes a gripping device borne by the part 32′ of the support device 32. This gripping device here takes the form of a tab 46 extending radially inwards from the angular ring sector 34′, to form the axial coupling member. This tab 46 preferably extends all along the associated angular ring sector 34′ thereof, so as to form a single axial coupling member within each angular structure sector 30′. This feature is moreover preferably retained for all embodiments involving angular ring sectors. Each angular structure sector 30′ also comprises another tab 66, extending radially inwards from the angular ring sector 34′, parallel with the tab 46. The tab 66 also extends all along the associated angular ring sector 34′ thereof, and it corresponds to that of the two tabs 46, 66 at the greatest distance axially from the second end of the lateral package body 8.

By virtue of the association of the angular ring sector 34′ and the two tabs 46, 66, each gripping device adopts, in the cross-section considered outside of the lugs 36, a general recumbent U shape when the axis 2 is arranged vertically, with the hollow of the U oriented radially inwards.

On the first axial end 8a, a single axial holding element 52 is provided, formed by an annular collar extending radially outwards relative to the axis 2. Under this collar 52, in the first end 8a, an annular groove 70 is defined wherein the axial coupling tab 46 is intended to be housed in the coupled configuration of each structure sector 30′. This solution reinforces the mechanical hold of the handling structure on the package even further.

Thus, the tab 66 of each structure sector 30′ forms one of the arms of the U which serves as an axial support for this sector 30′ on the collar 52 of the first axial end 8a. The tab 46 forms for its part the other arm of the U, and constitutes the axial coupling member housed in the groove 70, while being arranged in contact or axially facing the axial stop surface 60 defined by the collar 52, in the coupled configuration.

Finally, the base of the U, formed by the angular ring sector 34′ oriented vertically in FIGS. 8 to 10, constitutes a radial stop member which, in the coupled configuration, finds itself in contact or radially facing a periphery of the collar 52, as seen in FIG. 10. The cooperation obtained between these elements 34′, 52 enables a radial coupling between the lateral package body 8 and the angular structure sector 30′, particularly useful during a tilting operation of the package 1.

As mentioned above, in the coupled configuration, the axial coupling tab 46 finds itself axially facing or in contact with the axial stop surface 60 defined by the axial holding collar 52, this surface 60, preferably orthogonal to the axis 2, being oriented towards the second axial end of the lateral package body 8. It is the cooperation between these two elements 52, 60 which provides the axial mechanical coupling between each angular handling structure sector 30′ and the package 1, at the first axial end 8a thereof on the cover side.

For the mechanical coupling, each angular structure sector 30′ is first positioned relative to the package 1, such that it is radially separated therefrom, with the hollow of its U oriented radially facing the collar 52, as shown in FIG. 8. From this non-coupled configuration, each angular structure sector 30′ is moved individually and relative to the first axial end 8a by translation of this sectors, again in the virtual relative movement plane P arranged orthogonally to the axis 2. The directions of translation of the two sectors 30′ are represented schematically by the arrows 74 in FIG. 8. This plane P therefore passes through each angular ring sector 34′ and the collar 52 throughout the movement of the structure sectors 30′. During these movements, each axial coupling tab 46 is gradually inserted into the groove 70, until it finds itself in the bottom of this groove, arranged axially facing or in contact with the axial holding tab 52, as seen in FIG. 10.

The two sectors 30′ are then assembled end-to-end with bolts 76, shown in FIG. 9. The coupling carried out then makes it possible to perform the required handling operations, as indicated for the first preferred embodiment described above.

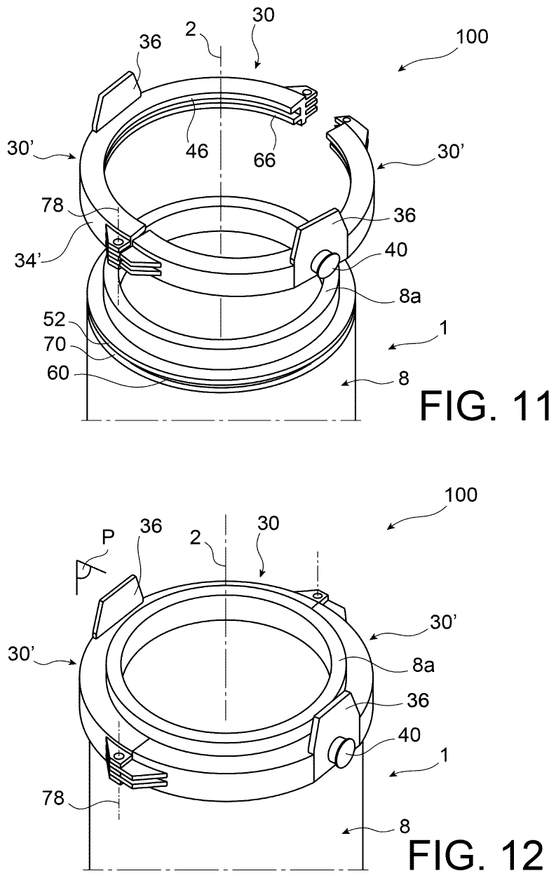

FIGS. 11 and 12 show an alternative to the second embodiment described above. Elements bearing the same reference number therefore correspond to identical or similar elements.

The only major difference lies in that during the assembly of the angular ring sectors 30′ on the first axial end 8a, these two sectors 30′ are connected to one another in a hinged manner at two adjacent ends, which are therefore connected end-to-end. The two other ends remain free, so as to be able to open the hinged structure 30, in order to insert the first axial end 8a between the two sectors 30′. This feature also applies when the number of sectors 30′ is greater than two, only two adjacent ends remaining free to be able to open the hinged structure.

Once this insertion has been carried out, and the openings of the U shapes arranged radially facing the collar 52 in the plane P, the mechanical coupling is carried out by pivoting the two sectors 30′ in relation to each other along the hinge axis 78 thereof, to close this structure 30 and make it tend towards a structure of annular geometry. Hence, each axial coupling tab 46 is gradually inserted into the groove 70 of the first end 8a, until it finds itself in the bottom of this groove, arranged axially facing or in contact with the axial holding tab 52. The two sectors 30′ are then assembled end-to-end with bolts, at the two free ends.

Obviously, in this alternative, the two connected ends of the two angular structure sectors 30′ can be connected other than by a hinge, the selected connection nevertheless needing to allow the opening and closure described above to ensure the assembly of the structure 30 around the package 1.

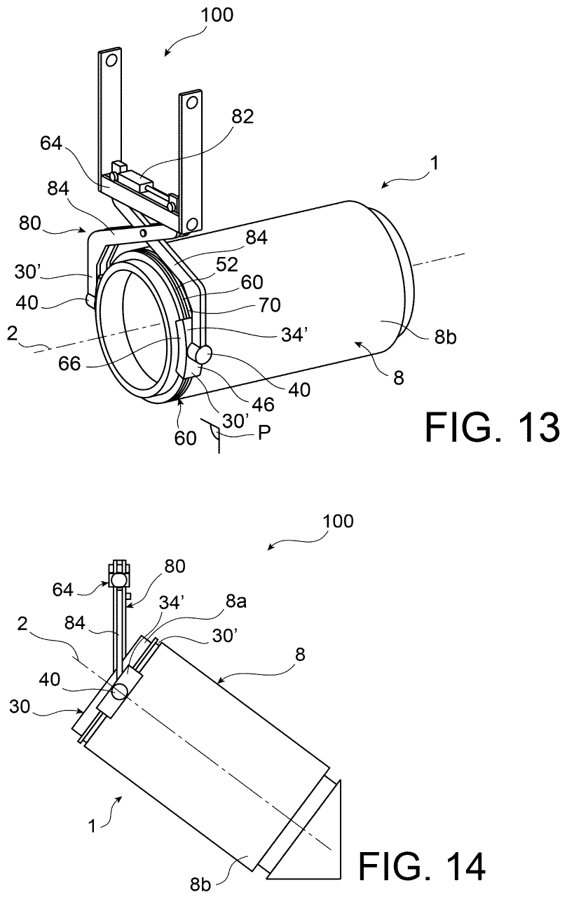

FIGS. 13 and 14 furthermore show another alternative to the second embodiment. Elements bearing the same reference number therefore also correspond to identical or similar elements here.

In this alternative, one of the major differences lies in the angular range of the two structure sectors 30′, considerably less than 180°. Thus, the two sectors 30′ are preferably arranged diametrically opposite, spaced apart from each other along the circumferential direction so as to only form a partial annular structure. For example, each sector 30′ can extend over 10 to 45°.

For the mechanical coupling of these angular structure sectors 30′ on the axial end 8a of the lateral package body, a movement actuation structure 80 is provided, opening and closing the removable handling structure 30 thus composed of the two sectors of reduced angular amplitude. The structure 80 for actuating the movement of the sectors 30′ can take any form, for example that of two actuation arms 84 arranged in a X and hinged at the centre thereof. With such a design, two ends of the X are respectively connected to the two sectors 30′, being preferably hinged on the two handling trunnions 40. Moreover, the two other ends of the X are for example connected on the lifting beam 64, while being connected to each other by a cylinder 82 capable of adjusting the spacing thereof, and therefore the radial spacing between the two structure sectors 30′ intended to engage with the collar 52.

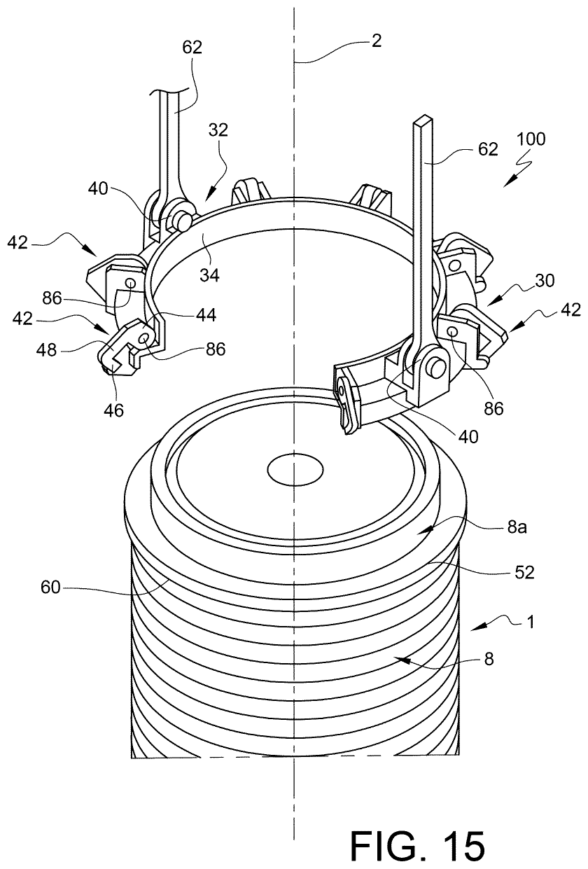

With the mechanical coupling of the sectors 30′ on the collar 52 of the end 8a of the lateral package body, by moving these sectors in the plane P in response to the control of the cylinder 82, handling operations of the assembly 100 can be envisaged. Among these operations, a tilting of the assembly 100 is shown in FIG. 14, during which the actuation arms 84 remain vertical by pivoting relative to the trunnions 40 whereon they are hinged. FIG. 15 represents a third preferred embodiment of the invention, wherein the U-shaped gripping devices 42 are each intended to cooperate with the same collar 52 of the first axial end 8a of the lateral package body 8. In this third embodiment, having many common features with the first embodiment, the U-shaped gripping devices 42 are pivotably mounted on the ring 34 (shown only partially) of the support device 32, along tangentially oriented pivoting axes 86.

Thus, when the ring 34 rests on the collar 52, the switch from the non-coupled configuration of the handling structure 30, to the coupled configuration with the package 1, is performed by pivoting each gripping device 42 relative to the ring 34, along the axes 86 through the arms of the U shapes opposite the arms forming the axial coupling member 46. Once these pivoting operations have been carried out, each axial coupling member 46 finds itself in contact or axial facing the annular axial stop surface 60 defined by the collar 52.

In this third embodiment represented in FIG. 15, the handling members 40 take the form of forks cooperating with the push rods 62. The number of gripping devices 42 can for example be between four and ten.

Of course, various modifications may be made by the person skilled in the art to the invention as described, by way of non-limiting examples only and according to the scope defined by the appended claims. In particular, the different preferred embodiments can be combined with each other.

What is claimed is:

1. Assembly (100) comprising a package for transporting and/or storing radioactive materials, the package including a lateral package body, a bottom and a removable cover, the lateral package body extending about a central longitudinal axis of the package passing through the bottom and the cover, the lateral package body comprising a first axial end on the cover side, as well as a second axial end opposite the first, on the package bottom side,
the assembly also comprising a removable handling structure designed to be removably coupled on the first axial end of the lateral package body, the handling structure comprising a support device, as well as at least two separate package handling members rigidly connected to the support device, the latter extending about the first axial end of the lateral package body, in a coupled configuration of the handling structure with the package,
wherein the first axial end of the lateral package body includes one or more axial holding elements of the handling structure, extending radially outwards relative to the central longitudinal axis, each axial holding element including an axial stop surface oriented towards the second axial end of the lateral package body,
in that the removable handling structure includes at least one gripping device borne by the support device, each gripping device comprising an axial coupling member to the first axial end of the lateral package body,
and in that in the coupled configuration of the handling structure, each axial coupling member is in contact or axially facing the axial stop surface of one of said one or more axial holding elements provided on the first axial end of the lateral package body.

2. Assembly according to claim 1, wherein it is designed such that the switch from a non-coupled configuration of the handling structure, to the coupled configuration of this handling structure to the package, is performed by moving the support device of the handling structure, relative to the first axial end of the lateral package body.

3. Assembly according to claim 2, wherein it is designed such that the relative movement is performed with the support device and the first axial end of the lateral package body remaining both inscribed in the same virtual relative movement plane, arranged orthogonally to the central longitudinal axis of the package.

4. Assembly according to claim 3, wherein it is designed such that the relative movement is performed by rotating the support device relative to the first axial end of the lateral package body, along an axis of relative rotation corresponding to the central longitudinal axis of the package.

5. Assembly according to claim 4, wherein each of the axial coupling members forms, with the associated axial holding element thereof provided on the first axial end of the lateral package body, a bayonet or claw coupling mechanism.

6. Assembly according to claim 4, wherein the support device includes a ring along which the gripping devices are spaced apart.

7. Assembly according to claim 4, wherein the gripping devices also each include a radial stop member cooperating with the first axial end of the lateral package body.

8. Assembly according to claim 3, wherein the removable handling structure is made from several angular structure sectors (30′), each of the sectors (30′) comprising:
a part (32′) of the support device;
at least one of the handling members;
at least one gripping device.

9. Assembly according to claim 8, wherein said part (32′) of the support device takes the form of an angular ring sector (34′), and in that said at least one gripping device takes the form of a tab extending radially inwards from the angular ring sector (34′), to form the axial coupling member, each tab extending preferably all along the associated angular ring sector (34′) thereof, so as to form a single axial coupling member inside each angular structure sector (30′).

10. Assembly according to claim 8, wherein in the coupled configuration, the angular structure sectors (30′) are mounted end-to-end to form an annular structure together, or the angular structure sectors (30′) are spaced apart so as to only form a part of an annular structure.

11. Assembly according to claim 8, wherein said one of more axial holding elements, provided on the first axial end of the lateral package body, is formed by an annular collar extending radially outwards relative to the central longitudinal axis.

12. Assembly according to claim 8, wherein the parts (32′) of the support device each form a radial stop member cooperating with the first axial end of the lateral package body.

13. Assembly according to claim 8, wherein it is designed such that the movement of each angular structure sector (30′), relative to the first axial end of the lateral package body, is performed by translation of the angular structure sector (30′) relative to the first axial end, in said virtual relative movement plane arranged orthogonally to the central longitudinal axis of the package.

14. Assembly according to claim 8, wherein it is designed such that during the movement of the angular structure sectors (30′), relative to the first axial end of the lateral package body to arrive at the coupled configuration, said angular structure sectors (30′) are connected to each other, preferably:
either end-to-end at only some of the ends thereof;
or via a structure for actuating the movement of the angular structure sectors (30′).

15. Assembly according to claim 1, wherein it is designed such that the switch from a non-coupled configuration of the handling structure, to the coupled configuration of this handling structure to the package, is performed by moving each gripping device of the handling structure, relative to the support device of said structure.

16. Assembly according to claim 1, wherein the handling members are provided in a number of two to four, and in that they each take the form of a trunnion, a fork, or a lug.

17. Assembly according to claim 1, wherein it comprises a device for locking the removable handling structure, in the coupled configuration with the first axial end of the lateral package body.
